(19) United States
(12) Patent Application Publication
(10) Pub. No.: US 2006/0070483 A1
(43) Pub. Date: Apr. 6, 2006

(54) Brake and clutch lever height adjusters

(76) Inventor: James J. Dimsey, Elm Grove, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/958,994

(22) Filed: Oct. 5, 2004

(51) Int. Cl. G05G 1/04

(52) U.S. Cl. 74/525

(57) ABSTRACT

A brake or clutch lever comprises a lever that pivots about an axis, a lever mounting structure from which the lever extends, and a thumbwheel having a cam thereon. The cam is disposed directly between the lever and the lever mounting structure. The thumbwheel rotates about an axis that is perpendicular to the axis of lever pivoting. Also provided is a method of adjusting a height of a brake or clutch lever. A grip portion of a brake or clutch lever is lifted away from a handlebar. A thumbwheel having a cam thereon is rotated about an axis that is perpendicular to a pivot axis of the brake or clutch lever. The brake or clutch lever is lowered toward the handlebar. A method of assembling a brake or clutch lever height adjuster is also provided.

### BACKGROUND OF THE INVENTION

1. Field of the Invention

The invention relates to brake and clutch levers for motorcycles and the like, whose grip heights can be adjusted to accommodate different hand sizes. More particularly, the invention relates to brake and clutch lever height adjusters.

2. Discussion of the Related Art

Motorcycles, ATVs, and similar vehicles typically employ brake and clutch levers for actuating one or more brakes or clutches of the vehicle to change the vehicle's speed. Brake levers, for example, are normally attached to the right side of a handlebar adjacent the right handgrip. The brake lever is pulled toward the handlebar to activate the brake, typically by actuating a cable or by directly actuating a master cylinder. The grip height of some levers can be adjusted to accommodate different hand sizes. This is useful for customizing a brake system to the needs of an individual operator and/or in permitting different operators to drive the. vehicle.

Some traditional brake lever height adjusters employ a setscrew that is positioned either between the lever and its mount or between sections of the lever to vary the spacing between those components and, thus, vary the grip height. These setscrews usually require tools for adjustment, and most alter the lever's mechanical advantage as a result of grip height adjustment. They are also aesthetically unattractive.

Other brake lever height adjusters employ a thumbwheel that acts on an internal threaded linkage or similar structure. These systems are, generally speaking, very conspicuous to the casual observer and, hence, also aesthetically unattractive. They also tend to be relatively difficult to adjust with one hand. The adjustment mechanism also tends to be relatively complex because the thumbwheel acts on a pivoting linkage assembly rather than directly on the lever-mounting bracket or between sections of a lever.

The need therefore has arisen to provide brake and clutch lever height adjusters that are relatively simple to manufacture, assemble, and use.

The need has additionally arisen to provide aesthetically pleasing brake and clutch lever height adjusters.

Much of the following description is directed towards brake levers for simplicity only. However, the inventive arrangements are analogous to clutch levers as well.

### SUMMARY OF THE INVENTION

In accordance with a first aspect of the invention, one or more of the above-identified needs is met by providing a brake or clutch lever that includes a lever that pivots about an axis, a lever mounting structure from which the lever extends, and a thumbwheel having a cam thereon. The cam is disposed directly between the lever and the lever mounting structure. The thumbwheel rotates about an axis that is perpendicular to the axis of lever pivoting.

In accordance with a preferred embodiment of the invention, the brake or clutch lever height adjuster also includes a dog that is provided on the bottom surface of the thumbwheel. The dog maintains the thumbwheel in position in the absence of user-imposed rotational forces.

The brake or clutch lever height adjuster does not alter the mechanical advantage or cable tension upon adjusting lever height.

Also provided is a method of adjusting a height of a brake or clutch lever. For example, a grip portion of a brake lever is often lifted away from a handlebar. A thumbwheel having a cam thereon is rotated about an axis that is perpendicular to a pivot axis of the brake lever. The brake lever is lowered toward the handlebar.

A method of assembling a brake or clutch lever height adjuster is also provided.

The benefits provided by the inventive brake or clutch lever height adjuster are particularly (but by no means exclusively) applicable to motorcycles.

In accordance with still other aspects of the invention, a method of making a brake or clutch lever height adjuster configured at least generally as described above and a method of using such brake or clutch lever height adjuster are additionally provided.

Other objects, features, and advantages of the invention will become apparent to those skilled in the art from the following detailed description and accompanying drawings. It should be understand, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a side elevation view of a brake lever and a brake lever height adjuster made in accordance with a preferred embodiment of the invention installed on a motorcycle handlebar and showing the lever in its deactuated or at-rest position;

FIG. 2 is an exploded view of the lever of FIG. 1;

FIG. 3 is a sectional view of the lever of FIG. 1 through line 3-3 showing the brake lever height adjuster in a first position to affect a first squeeze lever height;

FIG. 4 is fragmentary sectional view corresponding to FIG. 3 and showing the brake lever height adjuster in a second position to affect a second squeeze grip height;

FIG. 5 is a top plan view of a thumbwheel of the brake lever height adjuster;

FIG. 6 is a bottom plan view of a thumbwheel of the brake lever height adjuster;

FIG. 7 is a side elevation view of the lever or FIG. 1, showing a grip height adjustment operation;

FIG. 8 is a partial exploded view of a brake lever and a brake lever height adjuster made in accordance with an alternative embodiment of the invention; and

FIG. 9 is a partial exploded view of a clutch lever and a clutch lever height adjuster made in accordance with another alternative embodiment of the invention.

### DETAILED DESCRIPTION OF THE PREFERRED EMBODIMENTS

1. A First Preferred Embodiment of a Brake Lever Height Adjuster

A wide variety of different brake and clutch lever height adjusters for a variety of different applications could be constructed in accordance with the invention as defined by the claims. Hence, while a preferred embodiment of the invention will now be described with reference to a motorcycle brake lever height adjuster for ease of reference, it should be understood the invention is in no way so limited. It is also usable with clutches as well as with brakes, and also with a variety of different vehicles, such as bicycles and ATVs. It is also usable with a variety of other brake or clutch systems, such as direct hydraulic, cable hydraulic, and cable actuated brake and clutch systems.

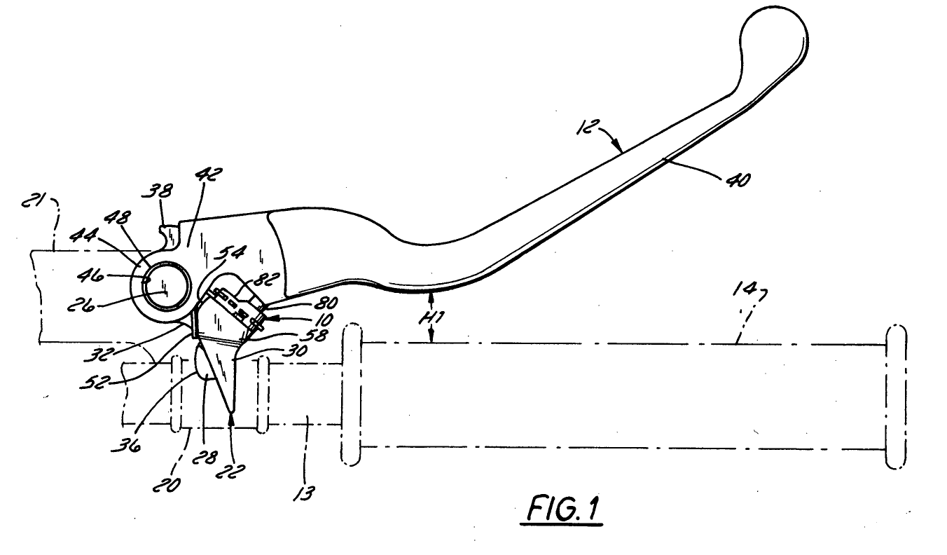

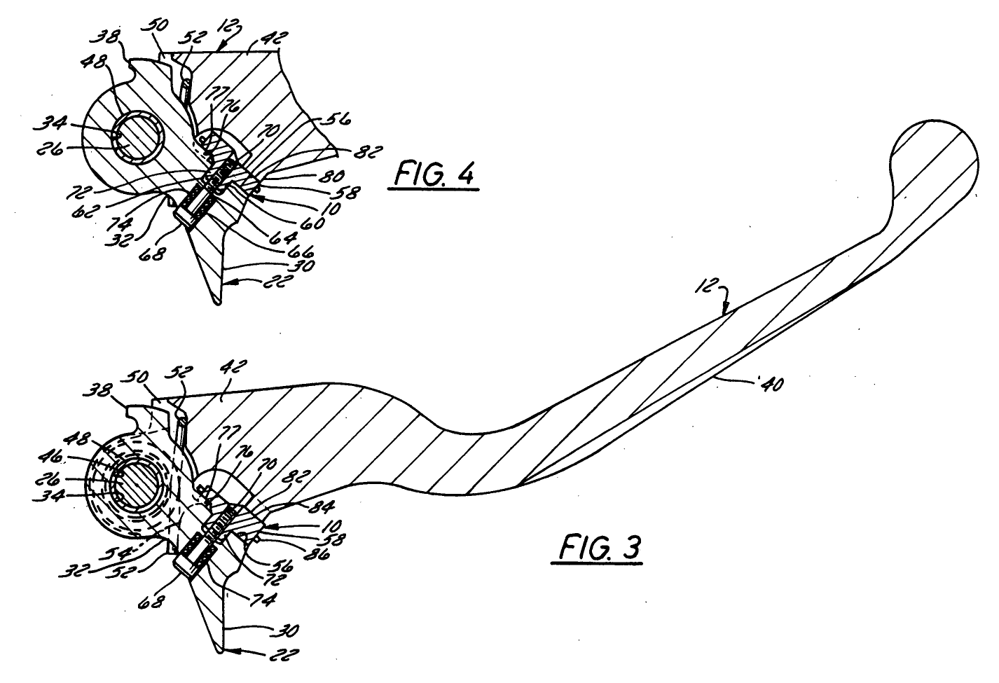

Referring now to FIGS. 1-4, a brake lever height adjuster 10 constructed in accordance with one embodiment of the invention is shown as being used on a brake lever 12 installed on a conventional motorcycle including handlebars 13. The brake lever 12 is positioned on the handlebar 13 adjacent an inboard end 16 of a right handgrip 14 in the illustrated embodiment, although it could also be positioned on the handlebar 13 adjacent an inboard end 16 of a left handgrip 18. It is mounted on the handlebar 13 by a bracket 20 shown only schematically in FIG. 1 and only in phantom that also bears or includes a master cylinder 21 (also shown only schematically in FIG. 1 and only in phantom). The lever 12 of this embodiment is a two-piece lever 12. A mounting structure that includes an actuator 22 supports the lever 12, and the lever height adjuster 10 is positioned directly between the actuator 22 and the lever 12. (Alternatively, the lever 12 could be a one-piece lever 12, and the height adjuster 10 could be positioned between the lever 12 and its mounting bracket 20 or other support). The actuator 22 and lever 12 are held together by a pivot pin 26 that also mounts the lever 12 on the mounting bracket 20 so as to permit the lever 12 to pivot as a whole about a horizontal pivot axis to reduce the lever height and apply the master cylinder 21.

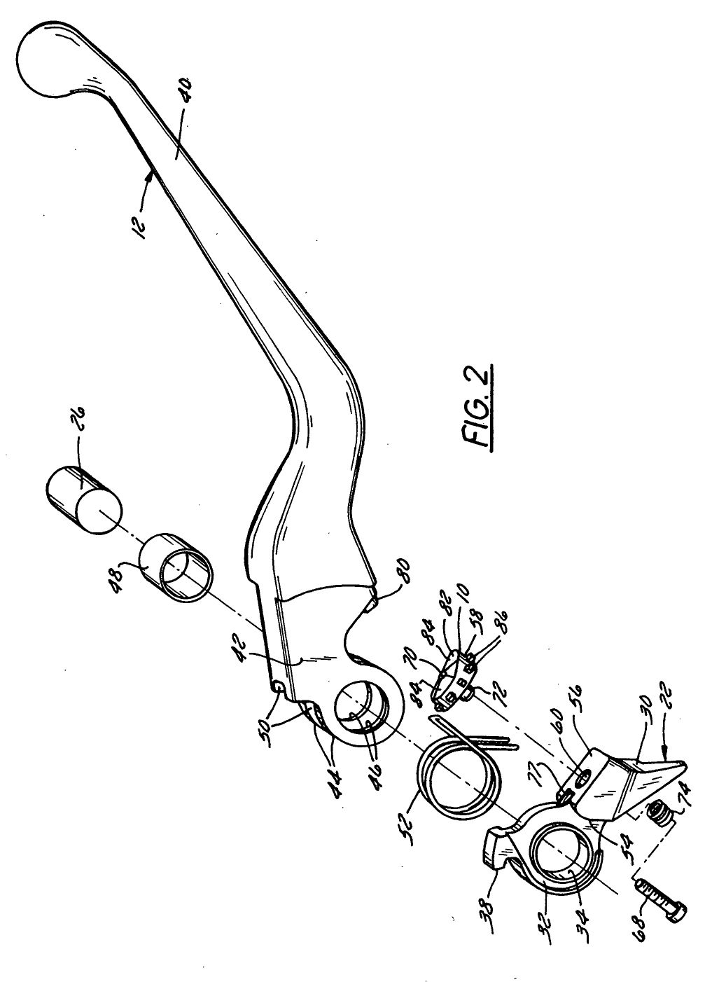

Still referring to FIGS. 1 and 2, the actuator 22 includes a lower actuator portion 28, a central adjuster mounting portion 30, and an upper lever mounting portion 32 having an opening 34 formed therethrough. An inboard surface 36 of the actuator portion 28 is configured to rest against a master cylinder piston (not shown) and to apply the master cylinder 21 upon lever actuation. A stop lug 38 is formed on the upper end of the lever mounting portion 32 for reasons detailed below.

The lever 12 includes an outboard grip portion 40 and an inboard mounting portion 42. The grip portion 40 of the lever 12 extends generally parallel to the handgrip 14 when the lever 12 is in its at-rest position and is spaced from the handgrip 14 by an average height whose thickness can be varied by operation of the lever height adjuster 10. The mounting portion 42 includes two generally circular projections 44 each defining an opening 46 therein. The two circular projections 44 slidingly receive the grip mounting portion 32 of the actuator 22. The diameter of the opening 34 in the actuator 22 is substantially the same as the diameter of the openings 46 in the mounting portion 42 of the lever 12 such that they can all receive a bushing 48 through which the pivot pin 26 passes. An inboard facing notch 50 is formed in the upper portion of the mounting portion 42 so as to receive the stop lug 38 of the actuator 22. The notch 50 also receives on end a torsion spring 52 that surrounds the bushing 48. The opposite end of the torsion spring 52 rests on the inboard portion of the actuator 22 so to bias the actuator 22 and lever 12 toward one another. The torsion spring 52 holds the mounting portion 42 and the actuator 22 together and biases the lever 12 as a whole toward the master cylinder 21.

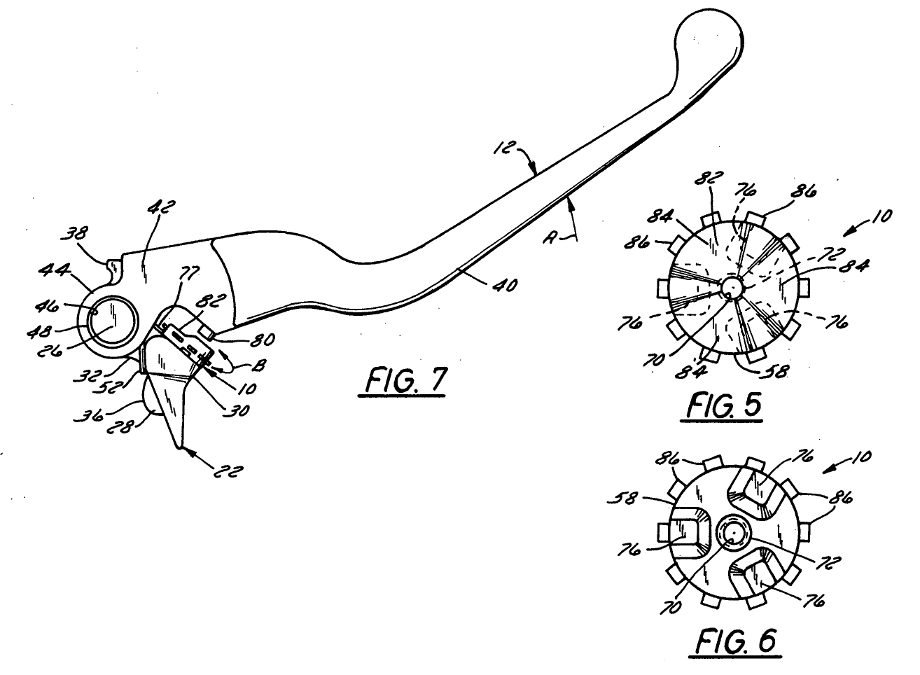

The adjuster mounting portion 30 of the actuator 22 includes an arcuate outer surface 54 against which an end of the torsion spring 52 rests. It also includes a generally upwardly facing planar thumbwheel support surface 56 configured to support a thumbwheel 58 of the lever height adjuster 10. A stepped bore 60 extends downwardly though the thumbwheel support surface 56. The bore 60 has an upper portion 62 having a first diameter, a threaded central portion 64 having a second diameter that is smaller than the first diameter, and a lower portion 66 having a third diameter substantially equal to the first diameter. The bore 60 receives a screw 68 from below that is threaded into a tapped bore 70 in a post 72 on the underside of the thumbwheel 58. The post 72 is received in the upper portion 62 of the bore 60. A spring 74 in the lower portion 66 of the bore 60 surrounds the screw 68 so as to bias the screw 68 and thumbwheel 58 downwardly. Referring now to FIGS. 5 and 6, dogs 76 are provided on the bottom surface of the thumbwheel 58 so as to engage detents (not shown) on the thumbwheel support surface 56. The dogs 76 maintain the thumbwheel 58 in position in the absence of user-imposed rotational forces on the thumbwheel 58 while allowing the thumbwheel 58 to rise against the force of the spring 74 and rotate upon the imposition of those actuating forces. The thumbwheel 58 is rotated about an axis that is perpendicular to the axis of the brake lever 12 pivoting.

Referring back to FIGS. 1-4, a lug 80 on the bottom surface of the mounting portion 42 of the lever 12 rests on the upper surface of the thumbwheel 58, hence setting the height of the lever 12. Hence, the thumbwheel 58 acts directly on the lever 12 and the actuator 22 rather than an intermediate structure. This height is adjusted by making the thumbwheel 58 of non-uniform thickness so that it presents a cam 82 on its upper surface, and the lug 80 hence acts as a cam follower. The cam 82 could be formed by a continuous ramp on the upper surface of the thumbwheel 58, hence providing for infinitely variable grip height adjustment between the maximum height determined by the point of maximum thumbwheel thickness and the minimum height determined by the point of minimum thumbwheel thickness. In the preferred embodiment, which is best seen in FIGS. 5-6, however, the thumbwheel 58 is circumferentially divided into arcuate sections 84 of a number of discreet thicknesses, and hence provides a number of discreet adjusted positions. Three such sections 84 are provided in the illustrated embodiment, but fewer or more sections could be provided. The transition between each set of adjacent sections is preferably ramped rather than stepped to facilitate thumbwheel rotation even if the lug 80 is in light contact with the thumbwheel 58 during adjustment.

Rotation of the thumbwheel 58 sets the height of the lever 12 by bringing a selected one of the three arcuate sections 84 of the cam 82 into contact with the lug 80 on the mounting portion 42. This rotation is facilitated by nubs 86 on the outer periphery of the thumbwheel 58. Preferably, the thumbwheel 58 is dimensioned relative to the width of the lever 12 so that the thumbwheel 58 protrudes beyond the side of the lever 12 only as necessary for adequate operator access. Because the remainder of the thumbwheel 58 and the adjuster 10 as a whole are hidden from view of the casual observer, the adjuster 10 does not significantly alter the aesthetics of the lever 12.

Significantly, the brake lever height adjuster 10 does not alter the mechanical advantage. That is, the ratio of the output force produced by the brake lever 12 to the applied input force is not altered when the brake lever height is adjusted. Similarly, if the lever 12 were to be used in a cable actuated system, cable tension would not be altered when the brake lever height is adjusted.

2. Assembly and Use of the Brake Lever Height Adjuster

The lever 12 is assembled by mounting the thumbwheel 58 into the upper portion 62 of the bore 60 in the thumbwheel support surface 56 of the actuator 22 by inserting the screw 68 and spring 74 into the lower portion 66 of the bore 60. The torsion spring 52 is then positioned between the mounting portion 30 of the actuator 22 and the mounting portion 42 of the lever 12 to form an assembly having aligned openings 34 and 46, and the assembly is mounted on the mounting bracket 20 by inserting the bushing 48 and the pin 26 through the aligned openings 34 and 46 and inserting the pin 26 into mating bores (not shown) in the mounting bracket 20. At this time, the inboard surface of the actuator portion 28 of the actuator 22 rests against the master cylinder piston (not shown), and the lever 12 rests in a position in which the grip portion 40 of the lever 12 is spaced from the handgrip 14 by an average height Hi as seen in FIG. 1.

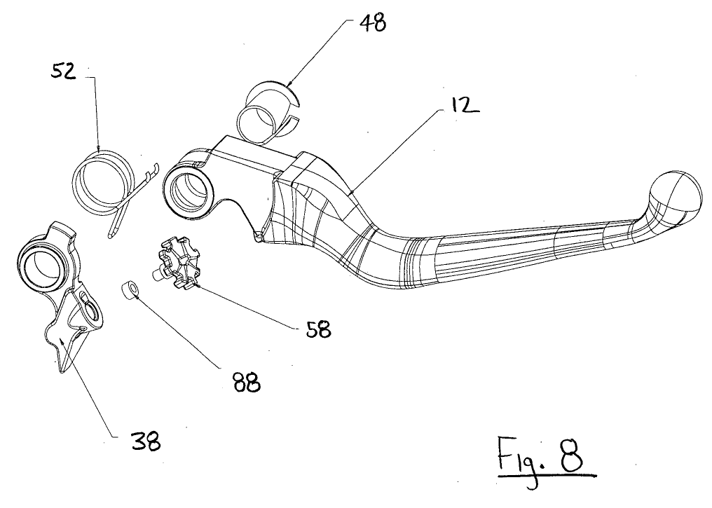

The brake lever height can be adjusted with one hand by pushing the brake lever 12 away from the handlebar 13 with the user's index finger (indicated by the arrow A of FIG. 7). The extent of this pivoting is limited by engagement between the stop lug 38 on the lever mounting portion 32 of the actuator 22 and the outboard end of the notch 50 in the mounting portion 42 of the lever 12. The operator then rotates the thumbwheel 58 about its axis by placing the thumb on the edge of the thumbwheel 58 and rotating it, as is indicated by the arrow B of FIG. 7. The radially spaced nubs 86 on the edge of the thumbwheel 58 provide a friction surface to facilitate rotation of the thumbwheel 58. This rotation moves one section of the thumbwheel 58, such as the section of maximum thickness, out of alignment with the lug 80 while moving another section 84, such as the section 84 of minimum thickness, into alignment with the lug 80. As a result, when the operator releases the lever 12 to let the lug 80 swing back into contact with the thumbwheel 58, the grip portion 40 of the lever 12 assumes a new height H2 (not shown) that is different from the initial height H1.

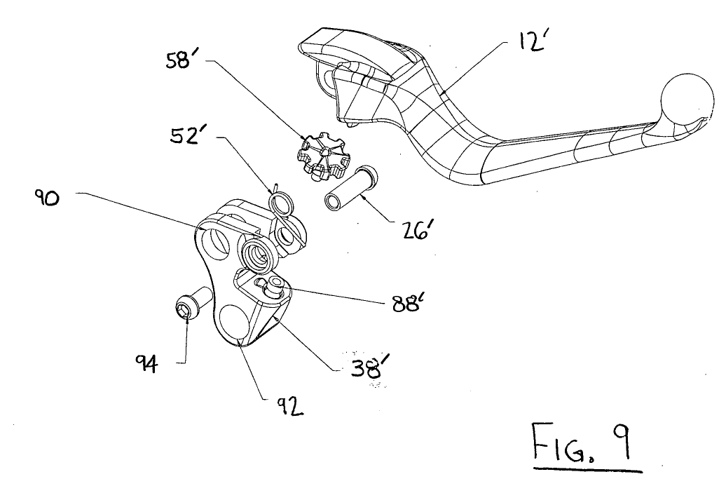

Referring now to FIG. 8, a partial exploded view of a brake lever 12 and a brake lever height adjuster 10 made in accordance with an alternative embodiment of the invention is depicted, in which the function thereof is as previously described. However, the screw 68 and spring 74 used to hold the thumbwheel 58 in the assembly of the previous figures has been replaced by an anti-rattling bushing 88 by techniques known to those skilled in the art. For example, a rubber bushing 88 is preferred.

Referring now to FIG. 9, a partial exploded view of a clutch lever 12′ and a clutch lever height adjuster 10′ made in accordance with an alternative embodiment of the invention is depicted, in which the function thereof is as previously described, except the brake lever 12 and brake lever height adjuster 10 have been respectively replaced by a clutch lever 12′ and a clutch lever height adjuster 10′ by techniques known to those skilled in the art, and in which like numerals generally depict like components. As with FIG. 8, the screw 68 and spring 74 used to hold the thumbwheel 58 in the assembly of the previous figures of the brake has been replaced by an anti-rattling bushing 88′ by techniques known to those skilled in the art. In addition, a first pivot hole 90 for cable attachment, a second pivot hole 92 for bushing and pin attachment to the clutch assembly, and a lever pivot screw 94 are provided by techniques known to those skilled in the art.

As indicated above, many changes and modifications may be made to the present invention without departing from the spirit thereof. The scope of some of these changes is discussed above. The scope of others will become apparent from the appended claims.

What is claimed is:

1. A lever comprising:
A. a lever that pivots about an axis;
B. a lever mounting structure from which the lever extends; and
C. a thumbwheel having a cam thereon and disposed directly between the lever and the lever mounting structure, wherein the thumbwheel rotates about an axis that is perpendicular to the axis of lever pivoting.

2. The lever of claim 1, further comprising a dog that is provided on the bottom surface of the thumbwheel and that maintains the thumbwheel in position in the absence of user-imposed rotational forces.

3. The lever of claim 1, wherein the thumbwheel does not alter the mechanical advantage or cable tension upon adjusting lever height.

4. The lever of claim 1, further comprising a spring that biases the lever and lever mounting structure together.

5. The lever of claim 1, wherein the lever is a two-piece lever, and the lever mounting structure includes an actuator of the lever, the actuator including a lever mounting portion and an adjuster mounting portion.

6. The lever of claim 1, wherein the cam comprises arcuate sections of the thumbwheel of distinct axial thicknesses and ramps interspersed between the sections.

7. The lever of claim 6, wherein the cam comprises three arcuate sections.

8. The lever of claim 1, further comprising an anti-rattling bushing.

9. The lever of claim 1 wherein the lever is a brake lever.

10. The lever of claim 1 wherein the lever is a clutch lever.

11. A method of adjusting a height of a lever comprising:
A. lifting a grip portion of a lever away from a handlebar;
B. rotating a thumbwheel having a cam thereon about an axis that is perpendicular to a pivot axis of the lever; and
C. lowering the lever toward the handlebar.

12. The method of claim 11, wherein the rotating step comprises engaging radially spaced nubs on an outer edge of the thumbwheel to facilitate rotation of the thumbwheel.

13. The method of claim 11, wherein the thumbwheel has discrete thicknesses such that rotation of the thumbwheel discretely adjusts a height of the lever relative to the handlebar.

14. The method of claim 11 wherein the lever is a brake lever.

15. The method of claim 1 wherein the lever is a clutch lever.

16. A method of assembling a lever height adjuster, comprising:
(A) providing a lever height adjuster including a thumbwheel having a cam thereon and a pivot axis;
(B) mounting the lever height adjuster directly between (1) a lever and (2) a lever mounting structure wherein the thumbwheel pivot axis is perpendicular to a pivot axis of the lever, the lever height adjuster including a cam that sets a gap between the lever and the lever mounting structure, the thickness of the gap varying with the angular orientation of the lever height adjuster relative to the lever and the lever mounting structure.

17. A brake lever comprising:
A. a lever that pivots about an axis;
B. a lever mounting structure from which the lever extends; and
C. a thumbwheel having a cam thereon and disposed directly between the lever and the lever mounting structure, wherein the thumbwheel rotates about an axis that is perpendicular to the axis of lever pivoting.

18. A clutch lever comprising:
A. a lever that pivots about an axis;
B. a lever mounting structure from which the lever extends; and
C. a thumbwheel having a cam thereon and disposed directly between the lever and the lever mounting structure, wherein the thumbwheel rotates about an axis that is perpendicular to the axis of lever pivoting.

19. A method of adjusting a height of a brake lever comprising:
A. lifting a grip portion of a brake lever away from a handlebar;
B. rotating a thumbwheel having a cam thereon about an axis that is perpendicular to a pivot axis of the brake lever; and
C. lowering the brake lever toward the handlebar.

20. A method of adjusting a height of a clutch lever comprising:
A. lifting a grip portion of a clutch lever away from a handlebar;
B. rotating a thumbwheel having a cam thereon about an axis that is perpendicular to a pivot axis of the clutch lever; and
C. lowering the clutch lever toward the handlebar.

21. A method of assembling a brake lever height adjuster, comprising:
(A) providing a brake lever height adjuster including a thumbwheel having a cam thereon and a pivot axis;
(B) mounting the brake lever height adjuster directly between (1) a lever and (2) a lever mounting structure wherein the thumbwheel pivot axis is perpendicular to a pivot axis of the lever, the brake lever height adjuster including a cam that sets a gap between the lever and the lever mounting structure, the thickness of the gap varying with the angular orientation of the brake lever height adjuster relative to the lever and the lever mounting structure.

22. A method of assembling a clutch lever height adjuster, comprising:
(A) providing a clutch lever height adjuster including a thumbwheel having a cam thereon and a pivot axis;
(B) mounting the clutch lever height adjuster directly between (1) a lever and (2) a lever mounting structure wherein the thumbwheel pivot axis is perpendicular to a pivot axis of the lever, the clutch lever height adjuster including a cam that sets a gap between the lever and the lever mounting structure, the thickness of the gap varying with the angular orientation of the clutch lever height adjuster relative to the lever and the lever mounting structure.
